(19) United States
(12) Patent Application Publication
(10) Pub. No.: US 2009/0055499 A1
(43) Pub. Date: Feb. 26, 2009

(54) Administration Of Time-Sensitive Email

(75) Inventor: Joe N. Brown, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/843,299

(22) Filed: Aug. 22, 2007

(51) Int. Cl. G06F 15/16

(52) U.S. Cl. 709/207

(57) ABSTRACT

Administration of time-sensitive email including creating, by a sender email module, an email message, the email message including a header and a message body; inserting, by the sender email module, in the header of the email message an identification of the email message as a time-sensitive email message, an identification of a time-server, and a time to open the email message; and sending, by the sender email module to a recipient email module, the email message.

### BACKGROUND OF THE INVENTION

1. Field of the Invention

The field of the invention is data processing, or, more specifically, methods, apparatus, and products for administration of time-sensitive email.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Users of computers today often communicate with one another through electronic means such as electronic mail. Email messages are often sent with information that is time-sensitive. Typical email clients have no capability to control the presentation of such time-sensitive information included in an email message. Typical email clients may present time-sensitive information at a time other than that intended by the sender.

### SUMMARY OF THE INVENTION

Methods, apparatus, and products for administration of time-sensitive email are disclosed that include creating, by a sender email module, an email message, the email message including a header and a message body; inserting, by the sender email module, in the header of the email message an identification of the email message as a time-sensitive email message, an identification of a time-server, and a time to open the email message; and sending, by the sender email module to a recipient email module, the email message.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for administration of time-sensitive email according to embodiments of the present invention.

FIG. 2 sets forth a block diagram of automated computing machinery comprising an exemplary computer useful in administration of time-sensitive email according to embodiments of the present invention.

FIG. 3 sets forth a flow chart illustrating an exemplary method for administration of time-sensitive email according to embodiments of the present invention.

FIG. 4 sets forth a flow chart illustrating a further exemplary method for administration of time-sensitive email according to embodiments of the present invention.

### DETAILED DESCRIPTION OF EXEMPLARY EMBODIMENTS

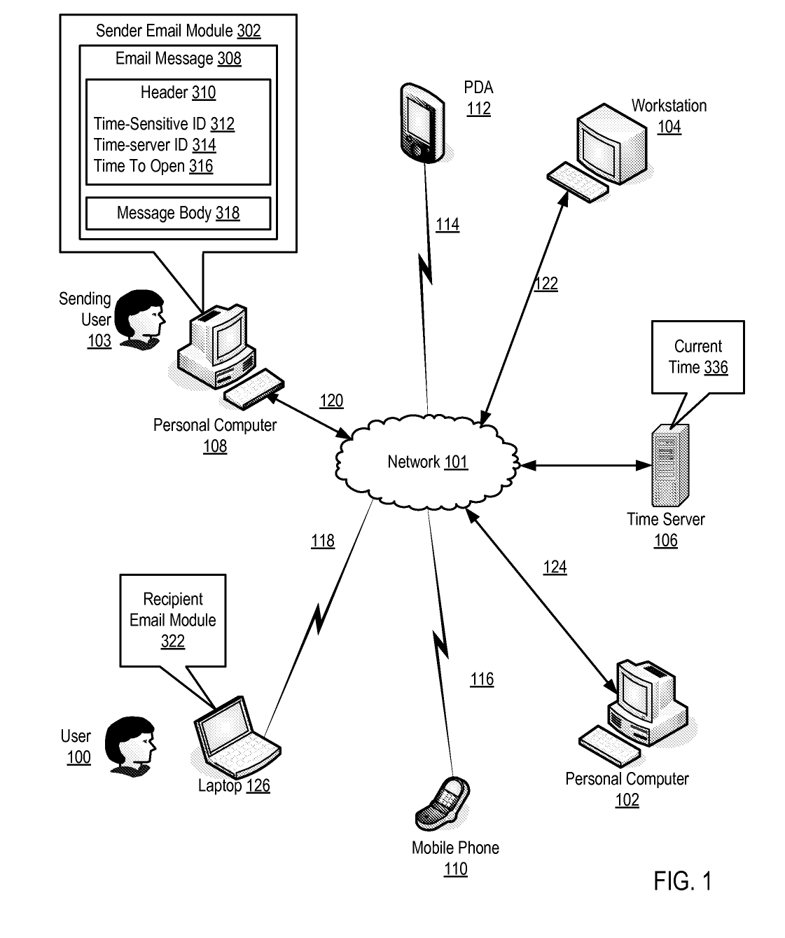

Exemplary methods, apparatus, and products for administration of time-sensitive email in accordance with the present invention are described with reference to the accompanying drawings, beginning with FIG. 1. FIG. 1 sets forth a network diagram of a system for administration of time-sensitive email according to embodiments of the present invention. The system of FIG. 1 is capable of creating, by a sender email module (302), an email message (308), the email message including a header (310) and a message body (318); inserting, by the sender email module (302), in the header (310) of the email message (308) an identification (312) of the email message as a time-sensitive email message, an identification (314) of a time-server, and a time to open (316) the email message (308); and sending (320), by the sender email module (302) to a recipient email module (322), the email message (308).

The system of FIG. 1 includes a sender email module (302) and a recipient email module (322). A sender email module is a module of computer program instructions that is capable of creating email messages and transmitting email messages. The email module is so called a ‘sender’ email module for clarity because the sender email module according to embodiments of the present invention operates generally for sending and not for receiving email messages.

A recipient email module (322) is a module of computer program instructions that is capable of receiving time-sensitive email messages and displaying the message body of time-sensitive email message to the recipient user. The email application is so called a ‘recipient’ email application for clarity because the recipient email module according to embodiments of the present invention operates generally for receiving and not for sending email messages.

Although the sender and recipient email modules of FIG. 1 are shown as separate module operating on physically distinct computing machinery, readers of skill in the art will immediately recognize that a time-sensitive email client application according to embodiments of present invention may include both a recipient email module and the sender email module. In this specification, the recipient and sender email modules will be described as separate modules for clarity.

The exemplary sender email module (302) of FIG. 1 is operating on the personal computer (108) which is coupled for data communications to the network (101) through wireline connection (120). The sender email module (302) may, however, operate on any automated computing machinery. The system of FIG. 1 includes many devices on which the sender email module (302) may operate including, for example:
a personal digital assistant (‘PDA’) (112) which is coupled for data communications to the network (101) by wireless connection (114);
a workstation (104) which is coupled for data communications to the network (101) by wireline connection (122); and
a mobile phone (110) which is coupled for data communications to the network (101) by wireless connection (116).
a personal computer (102) which is coupled for data communications to the network (101) by wireless connection (124).

In a similar manner, although shown in FIG. 1 as operating on the laptop (126) which is coupled for data communications to the network (101) by wireless connection (118), the recipient email module (322) may also operate on any the above mentioned devices.

The system of FIG. 1 also includes a time server (106). A time server is a server that reads the current time (336) from a reference clock and distributes this information to clients through a computer network. A time server may be a local network time server or an internet time server. The time reference used by a time server could be another time server on the network or the Internet, a connected radio clock or an atomic clock. The most common true time source is a Global Position System (‘GPS’) master clock.

The most widely-used protocol for distributing and synchronizing time is the Network Time Protocol (‘NTP’). The Network Time Protocol (NTP) is a protocol for synchronizing computer clocks over packet-switched, variable-latency data networks. NTP uses User Datagram Protocol (‘UDP’) port 123 as its transport layer. NTP is designed to resist the effects of variable latency or jitter.

The arrangement of servers and other devices making up the exemplary system illustrated in FIG. 1 are for explanation, not for limitation. Data processing systems useful according to various embodiments of the present invention may include additional servers, routers, and other devices, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

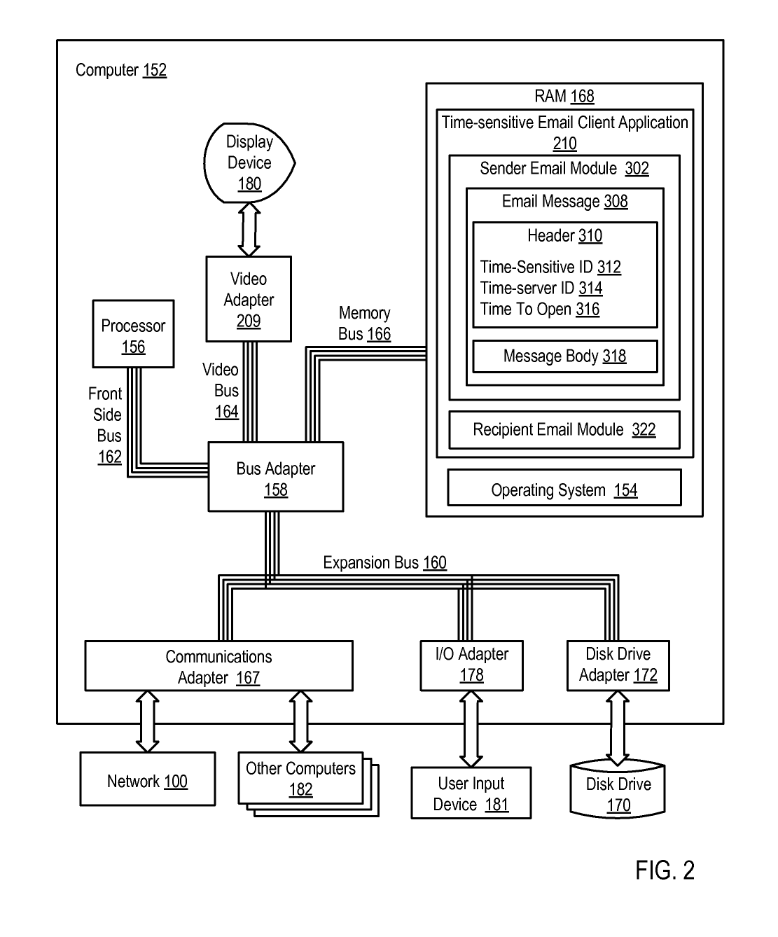

Administration of time-sensitive email in accordance with the present invention is generally implemented with computers, that is, with automated computing machinery. In the system of FIG. 1, for example, the time server (106), personal computer (108) and laptop (126), are implemented to some extent at least as computers. For further explanation, therefore, FIG. 2 sets forth a block diagram of automated computing machinery comprising an exemplary computer (152) useful in administration of time-sensitive email according to embodiments of the present invention. The computer (152) of FIG. 2 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a time-sensitive email client application (210). As mentioned above, a time-sensitive email client application (210) may be configured with both a sender email module and a recipient email module. The time-sensitive email client application (210) of Figure includes a sender email module (302), a module of computer program instructions useful in the administration of time-sensitive email messages according to embodiments of the present invention. The sender email module (302) is capable of creating an email message (308), the email message including a header (310) and a message body (318); inserting in the header (310) of the email message (308) an identification (312) of the email message as a time-sensitive email message, an identification (314) of a time-server, and a time to open (316) the email message (308); and sending to a recipient email module (322), the email message (308).

Also stored in RAM (168) is an operating system (154). Operating systems useful administration of time-sensitive email according to embodiments of the present invention include UNIX™, Linux™, Microsoft XP™, Microsoft Vista™, AIX™, IBM's i5/OS™, and others as will occur to those of skill in the art. The operating system (154), sender email module (302), and email message (308), in the example of FIG. 2 are shown in RAM (168), but many components of such software typically are stored in non-volatile memory also, such as, for example, on a disk drive (170). The computer (152) of FIG. 2 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for administration of time-sensitive email according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for administration of time-sensitive email according to embodiments of the present invention include modems for wired dial-up communications, Ethernet (IEEE 802.3) adapters for wired data communications network communications, and 802.11 adapters for wireless data communications network communications.

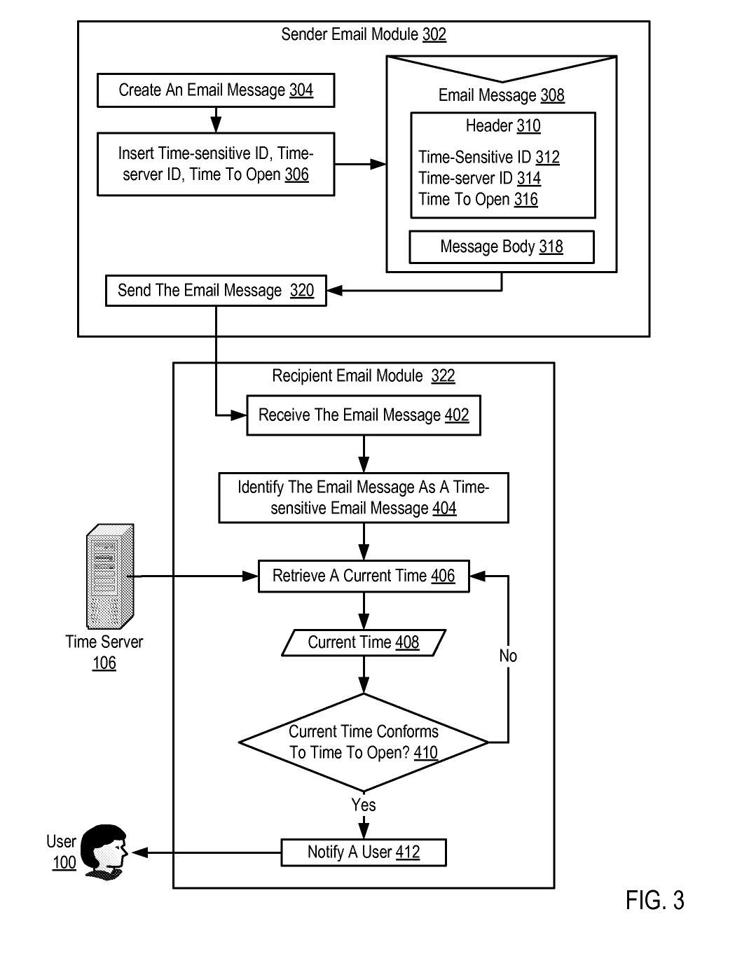

For further explanation, FIG. 3 sets forth a flow chart illustrating an exemplary method for administration of time-sensitive email according to embodiments of the present invention. Electronic mail (‘email’) is typically implemented as a store and forward method of composing, sending, storing, and receiving email messages over electronic communication systems.

The method of FIG. 3 includes creating (304), by a sender email module (302), an email message (308). As mentioned above, a sender email module is a module of computer program instructions that is capable of creating email messages and transmitting email messages. A sending user is a user that directs the sender email module through a computer or other automated computing machinery to create an email message and transmit the email message to a recipient email module and user. The sending user is the author of the message body of an email message.

Creating (304), by a sender email module (302), an email message (308) may be carried out by creating a text message having a header describing various aspects of the email and a message body including text from a sending user. The message body of an email message typically includes the content of the email message that a sending user intends to be displayed to a user that receives the email message. The header of an email message includes a group of fields that describe various aspects of the email message. In the method of FIG. 3 the email message (308) includes a header (310) and a message body (318). A typical header of an email message may include any of the following fields:
A ‘from’ field that identifies the email address, and optionally the name, of the sender of the message.
A ‘to’ field that identifies one or more email addresses, and optionally one or more names, of the receivers of the message.
A ‘subject’ field that includes a brief summary of the contents of the message body.
A ‘date’ field that identifies the local time and date that the message sent.
Others as will occur to those of skill in the art.

In addition to inserting the common fields in a typical header of an email message, the method of FIG. 3 also includes inserting (306), by the sender email module (302) in the header (310) of the email message (308), an identification (312) of the email message as a time-sensitive email message, an identification (314) of a time-server, and a time to open (316) the email message (308).

Inserting (306) an identification (312) of the email message as a time-sensitive email message may be carried out by creating in the header a field for an email message identification and inserting the time-sensitive identification in the field for the email message identification. A time-sensitive identification may be any unique identification for that email message including, for example, a Boolean indication that the email message is time sensitive.

Inserting (306) an identification (314) of a time-server may be carried out by creating in the header a field for a time server identification and inserting the time server identification in the field for the time server identification. A time server identification may be any unique identification of a time server such as, for example, a Uniform Resource Locator.

Inserting (306) a time to open (316) the email message (308) may be carried out by creating in the header one ore more fields for a time to open and inserting the time to open in the one or more fields. A time to open may be a lower time constraint, an upper time constraint or both.

For further explanation, consider the following exemplary header of a time-sensitive email message according to embodiments of the present invention:
From: MarySmith@example.com
To: JohnSmith@example.com
Subject: Winter Product Line
Date: Aug. 8, 2007
Email ID: Time-sensitive
Lower Time Constraint: 11-1-2007 6:01 UTC
Time Server ID: 0.pool.ntp.org

In the example above, the email header includes a ‘From’ field that identifies the email address of the sender of the email message. The email address of the sender of the message is MarySmith@example.com. In the example above, the email header includes a ‘To’ field that identifies the email address of the intended recipient of the email message. The email address of the intended recipient of the email message is JohnSmith@example.com.

In the example above, the email header includes a ‘Subject’ field that includes a brief summary of the contents of the message body. The brief summary of the contents of the message body in this example is “Winter Product Line.” In the example above, the email header includes a ‘Date’ field that identifies the local time and date that the message was sent. The local time and date that the message was sent is Aug. 8, 2007.

In the example above, the email header includes an ‘Email ID field’ that identifies whether the email message is a time-sensitive email message or a time-independent email message. In the example above, the email message is identified as a time-sensitive email message.

In the example above, the email header includes a ‘Lower Time Constraint’ field that identifies a time to open the email message. The time to open is a lower time constraint, the first time at which the recipient may open the email. The time to open the email message is 6:01 UTC on Nov. 1, 2007. The email message cannot be opened by the recipient until Nov. 1, 2007 at 6:01 UTC.

The time to open in this example is expressed in terms of UTC, Coordinated Universal Time. UTC is a high-precision atomic time standard. Time zones around the world are expressed as positive or negative offsets from UTC. Local time is UTC plus the time zone offset for that location, plus an offset for daylight saving time, if necessary. UTC is often also referred to as Zulu time. The current time provided by NTP servers is typically expressed in UTC. Although the above example shows the time to open as expressed in terms in UTC for clarity, readers of skill in the art will recognize that the time to open could also be expressed in terms of the senders local time or the recipients local time and later converted to UTC to determine whether the current time retrieved from the time server conforms to the time to open. Alternatively, the current time retrieved from the time server may be converted to the local time represented by the time to open specified in the header of the time-sensitive email message.

As mentioned above, a time server is a server that reads the current, actual time from a reference clock and distributes this information to clients through a computer network. A time server may be a local network time server or an internet time server. The time reference used by a time server could be another time server on the network or the Internet, a connected radio clock or an atomic clock. The most common true time source is a Global Position System (‘GPS’) master clock.

The most widely-used protocol for distributing and synchronizing time is the Network Time Protocol (‘NTP’). The Network Time Protocol (NTP) is a protocol for synchronizing computer clocks over packet-switched, variable-latency data networks. NTP uses User Datagram Protocol (‘UDP’) port 123 as its transport layer. NTP is designed to resist the effects of variable latency or jitter.

The exemplary email header above includes a ‘Time Server ID’ that identifies the time server to use to determine whether the current time conforms to the time to open. The recipient email module in this example uses the identification 0.pool.ntp.org to retrieve the current time.

In the exemplary email header above, the time to open is expressed in terms of a lower time constraint. A time to open is the time at which the recipient email module will allow a user of the recipient email module to view the message body of the time-sensitive email message. A time to open may include dates, days of the week, hours, minutes, seconds, and other unit of time as will occur to those of skill in the art. A time to open may be expressed as a ‘do not open before’ time, a ‘do not open after time,’ or as a combination of the two. A recipient email module will not allow a user to view the message body of a time-sensitive email having a time to open that is a do not open before time until the current time is greater than the do not open before time. Alternatively a recipient email module will allow a user to view the message body of a time-sensitive email having a time to open that is a do not open after time only as long as the current time is less than the do not open before time. The do not open before time is therefore a lower time constraint and the do not open after time is an upper time constraint. A combination of a do not open before and a do not open after time is a window of time in which the message body of the email may be displayed to a user.

Continuing with the above exemplary header, if the time to open is a combination of a do not open before and do not open after time, the exemplary header may recite:
From: MarySmith@example.com
To: JohnSmith@example.com
Subject: Winter Product Line
Date: Aug. 8, 2007
Email ID: Time-sensitive
Time Server ID: 0.pool.ntp.org
Lower Time Constraint: 11-1-2007 6:01 UTC
Upper Time Constraint: 11-2-2007 6:01 UTC

In the example above, the email header includes, in addition to a “Lower Time Constraint,” an “Upper Time Constraint” that identifies the time at which the recipient email program may no longer open the email message. The window of time for a recipient email program to open the email message, in this example, is between Nov. 1, 2007 at 6:01 UTC and Nov. 2, 2007 at 6:01 UTC.

In the method of FIG. 3, inserting (306), by the sender email module (302), in the header (310) of the email message (308) an identification (312) of the email message as a time-sensitive email message, an identification (314) of a time-server, and a time to open (316) the email message (308) may also include various ways of obtaining an identification of a time-server to be inserted in a header of a time-sensitive email message.

Inserting in the header of the email message an identification of the email message as a time-sensitive email message, an identification of a time-server, and a time to open the email message may, for example, include receiving from a sending user the identification of the time-server. A sending user may provide the identification of the time-server in various ways including, for example, using a keyboard to specify the identification, selecting the time-server from a list of time-servers, or other ways as will occur to those of skill in the art. That is, a sending user may provide the identification of a time server at the time the time sensitive email message created and sent.

For further explanation, consider that the sender email module provides the sending user with a graphical user interface that includes a drop down selection list of various time-servers. The list includes the following time servers:
0.pool.ntp.org
1.pool.ntp.org
2.pool.ntp.org

The sender may provide the identification of a time server to the email application by selecting 1.pool.ntp.org from the drop down selection list. The sender email module may also be configured to receive the identification of one or more alternative time servers to include in the email message header. Identification of one or more alternative time servers may be used in the case where the originally selected time server is no longer available at the time the recipient email module attempts to determine whether the current time conforms to the time to open in the header of the time-sensitive email message.

Inserting in the header of the email message an identification of the email message as a time-sensitive email message, an identification of a time-server, and a time to open the email message alternatively may include retrieving a pre-configured identification of the time-server from data storage. The sender email module may be pre-configured with a time server identification, such that, when a time-sensitive email is created and sent, the pre-configured time server identification is inserted in the header of the time-sensitive email message. The sender email module may also be configured to retrieve one of a number of pre-configured time server identification based on a set of rules defined by the sending user. The rules may, for example, specify a particular time-server to use when sending a time-sensitive email message to a particular recipient.

Due to various data communication delays, time servers physically closer to the recipients often provide more precise time then those time servers that are physically remote from a recipient. A sending user, then, may pre-configure a sender email module with a set of rules for all time-sensitive email messages addressed to any recipient that lives in a specific time zone, such as the Central Standard Time Zone. The rules may specify the identification of one or more particular time servers to insert into the header of such a time-sensitive email message, where the one or more particular time servers are physically close to the recipients in the Central Standard Time Zone.

The method of FIG. 3 also includes sending (320), by the sender email module (302) to a recipient email module (322), the email message (308). Sending (320), by the sender email module (302) to a recipient email module (322), the email message (308) is carried out by sending the email message through a data communications network according to the Simple Mail Transfer Protocol (‘SMTP’), Extended SMTP, Internet Message Access Protocol (IMAP), Post Office Protocol version 3 (POP3), or any other protocol as will occur to those of skill in the art.

The method of FIG. 3 also includes receiving (402), by the recipient email module (322), the email message (308) and identifying (404), by the recipient email module (322), the email message (308) as a time-sensitive email message. Identifying (404), by the recipient email module (322), the email message (308) as a time-sensitive email message may be carried out by parsing the header of the email message upon receipt of the email message and discovering in the header the identification of the email message as a time-sensitive email message.

The method of FIG. 3 also includes retrieving (406), by the recipient email module (322) from the time server (106) identified in the header (310), a current time (408). Retrieving (406), by the recipient email module (322) from the time server (106) identified in the header (310), a current time (408) may be carried out by using the time-server ID in the header of the email message to query an time server for the current time. If the time server queried is an NTP time server, for example, the server provides, in response to the query, a 64-bit time stamp that represents the current time. An NTP time stamp consists of a 32-bit seconds part and a 32-bit fractional second part. The NTP timescale uses an epoch of Jan. 1, 1900. An NTP time stamp of “ca64897d.57bb40b3” in hexadecimal, for example, is equivalent to 3,395,586,429 seconds and 343 milliseconds. Counting 3,395,586,429 seconds from Jan. 1, 1900 results in a time of Aug. 8, 2007 at 18 hours, 27 minutes, 09 seconds, and 343 milliseconds expressed in UTC.

The method of FIG. 3 also includes determining (410), by the recipient email module (322), whether the current time (408) conforms to the time to open (316) the email message (308) in the header (310). Determining (410) whether the current time (408) conforms to the time to open (316) the email message (308) in the header (310) is carried out in different ways depending upon whether the time to open is a ‘do not open before’ time, a ‘do not open after’ time, or a combination of the two. If the time to open is a do not open before time, then the recipient email module determines (410) whether the current time conforms to the time to open by determining whether the current time is greater than or equal to the time to open. If the time to open is a do not open before time, then the recipient email module determines whether the current time conforms to the time to open by determining whether the current time is less than or equal to the time to open. If the time to open is a window of time, having lower and upper time constraints, the recipient email module determines whether the current time conforms to the time to open by determining if the current time is within the lower and upper time constraints.

Instead of allowing a user to use the current time of the user's system clock to determine whether the current time conforms to the time to open the time-sensitive email message, the sending user requires the user to use the current time from a time server to make the determination. By requiring the user of a time-sensitive email message to use the current time from a time server to determine whether the current time conforms to the time to open the time-sensitive email message, the sending user ensures that the receiving user cannot circumvent the time to open by changing the user's current time on the user's computer.

If the current time (408) conforms to the time to open (316) the email message (308) in the header (310), the method of FIG. 3 continues by notifying (412), by the recipient email module (322), a user (100). Notifying the user may be carried out in various ways including for example, displaying a message to the user, displaying the message body of the email message, or moving the email message from a folder designated for time-sensitive email messages to another folder, such as the user's inbox, or in other ways as will occur to those of skill in the art.

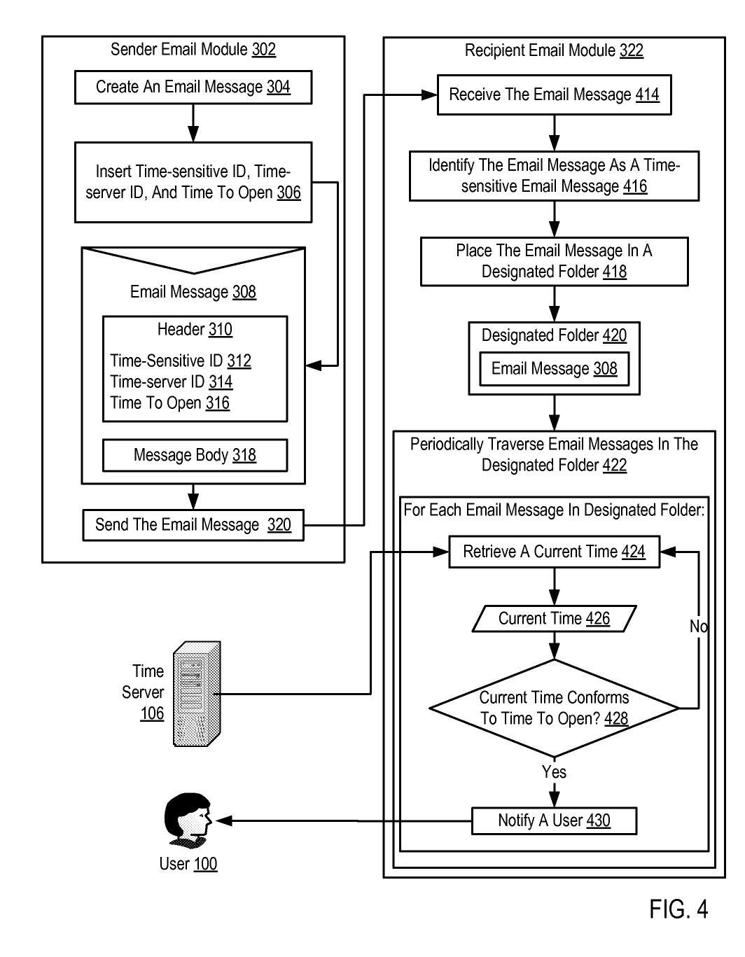

For further explanation, FIG. 4 sets forth a flow chart illustrating a further exemplary method for administration of time-sensitive email according to embodiments of the present invention. The method of FIG. 4 is similar to the method of FIG. 3 in that the method of FIG. 4 includes creating (304), by a sender email module (302), an email message (308), the email message including a header (310) and a message body (318); inserting (306), by the sender email module (302), in the header (310) of the email message (308) an identification (312) of the email message as a time-sensitive email message, an identification (314) of a time-server, and a time to open (316) the email message (308); and sending (320), by the sender email module (302) to a recipient email module (322), the email message (308).

The method of FIG. 4 differs from the method of FIG. 3, however, in that the method of FIG. 4 includes receiving (414), by the recipient email module (322), the email message (308) and identifying (416), by the recipient email module (322), the email message (308) as a time-sensitive email message. Identifying (416), by the recipient email module (322), the email message (308) as a time-sensitive email message is carried out by parsing the header and discovering that the email message identification field in the header includes the identification of a time-sensitive email message.

The method of FIG. 4 also includes placing (418), by the recipient email module (322), the email message (308) in a designated folder (420). A designated folder is data structure in which time-sensitive email messages are stored. The designated folder may be implemented in various forms including for example, a column of a table in a database, directory in a file system, a section of a markup document, and other forms as will occur to those of skill in the art. Placing (418), by the recipient email module (322), the email message (308) in a designated folder (420) is carried out in dependence upon the implementation of the designated folder. If the designated folder is a column of a table in a database, for example, the recipient email module (322) places the email message (308) in the designated folder by inserting into the column an identification of the email message. If the designated folder is a directory in a file system, for example, the recipient email module (322) places the email message (308) in the designated folder by storing the actual email message in the directory. If the designated folder is a section of a markup document, for example, the recipient email module (322) places the email message (308) in the designated folder by inserting in the section, an identification of the email message.

The method of FIG. 4 also includes periodically traversing (422), by the recipient email module (322), email messages in the designated folder (420). Traversing (422), by the recipient email module (322), email messages in the designated folder (420) is carried out by, for each email message in the designated folder (420), retrieving (424), by the recipient email module (322) from the time server (106) identified in the header of that email message, a current time (426); determining (428), by recipient email module (322), whether the current time (426) conforms to the time to open that email message identified in the header; and if the current time (428) conforms to the time to open that email message in the header, notifying (430), by the recipient email module (322), a user (100). Notifying the user may be carried out in various ways including for example, displaying a message to the user, displaying the message body of the email message, or moving the email message from the designated folder (420) for time-sensitive email messages to another folder, such as the user's inbox, or in other ways as will occur to those of skill in the art.

Exemplary embodiments of the present invention are described largely in the context of a fully functional computer system for administration of time-sensitive email. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for administration of time-sensitive email, the method comprising:
creating, by a sender email module, an email message, the email message including a header and a message body;
inserting, by the sender email module, in the header of the email message an identification of the email message as a time-sensitive email message, an identification of a time-server, and a time to open the email message; and
sending, by the sender email module to a recipient email module, the email message.

2. The method of claim 1 further comprising:
receiving, by the recipient email module, the email message;
identifying, by the recipient email module, the email message as a time-sensitive email message;
retrieving, by the recipient email module from the time server identified in the header, a current time;
determining, by the recipient email module, whether the current time conforms to the time to open the email message in the header; and
in response to determining that the current time conforms to the time to open the email message in the header, notifying, by the recipient email module, a user.

3. The method of claim 1 further comprising:
receiving, by the recipient email module, the email message;
identifying, by the recipient email module, the email message as a time-sensitive email message; and
placing, by the recipient email module, the email message in a designated folder.

4. The method of claim 3 further comprising:
periodically traversing, by the recipient email module, email messages in the designated folder including for each email message in the designated folder:
retrieving, by the recipient email module from the time server identified in the header of that email message, a current time;
determining, by recipient email module, whether the current time conforms to the time to open that email message identified in the header; and
in response to determining that the current time conforms to the time to open that email message in the header, notifying, by the recipient email module, a user.

5. The method of claim 1 wherein inserting in the header of the email message an identification of the email message as a time-sensitive email message, an identification of a time-server, and a time to open the email message further comprises receiving from a sending user the identification of the time-server.

6. The method of claim 1 wherein inserting in the header of the email message an identification of the email message as a time-sensitive email message, an identification of a time-server, and a time to open the email message further comprises retrieving a pre-configured identification of the time-server from data storage.

7. An apparatus for administration of time-sensitive email, the apparatus comprising a computer processor, a computer memory operatively coupled to the computer processor, the computer memory having disposed within it computer program instructions capable of:
creating, by a sender email module, an email message, the email message including a header and a message body;
inserting, by the sender email module, in the header of the email message an identification of the email message as a time-sensitive email message, an identification of a time-server, and a time to open the email message; and
sending, by the sender email module to a recipient email module, the email message.

8. The apparatus of claim 7 further comprising computer program instructions capable of:
receiving, by the recipient email module, the email message;
identifying, by the recipient email module, the email message as a time-sensitive email message;
retrieving, by the recipient email module from the time server identified in the header, a current time;
determining, by the recipient email module, whether the current time conforms to the time to open the email message in the header; and
in response to determining that the current time conforms to the time to open the email message in the header, notifying, by the recipient email module, a user.

9. The apparatus of claim 7 further comprising computer program instructions capable of:
receiving, by the recipient email module, the email message;
identifying, by the recipient email module, the email message as a time-sensitive email message; and
placing, by the recipient email module, the email message in a designated folder.

10. The apparatus of claim 9 further comprising computer program instructions capable of:
periodically traversing, by the recipient email module, email messages in the designated folder including for each email message in the designated folder:
retrieving, by the recipient email module from the time server identified in the header of that email message, a current time;
determining, by recipient email module, whether the current time conforms to the time to open that email message identified in the header; and
in response to determining that the current time conforms to the time to open that email message in the header, notifying, by the recipient email module, a user.

11. The apparatus of claim 7 wherein inserting in the header of the email message an identification of the email message as a time-sensitive email message, an identification of a time-server, and a time to open the email message further comprises receiving from a sending user the identification of the time-server.

12. The apparatus of claim 7 wherein inserting in the header of the email message an identification of the email message as a time-sensitive email message, an identification of a time-server, and a time to open the email message further comprises retrieving a pre-configured identification of the time-server from data storage.

13. A computer program product for administration of time-sensitive email, the computer program product disposed in a computer readable, signal bearing medium, the computer program product comprising computer program instructions capable of:
creating, by a sender email module, an email message, the email message including a header and a message body;
inserting, by the sender email module, in the header of the email message an identification of the email message as a time-sensitive email message, an identification of a time-server, and a time to open the email message; and
sending, by the sender email module to a recipient email module, the email message.

14. The computer program product of claim 13 further comprising computer program instructions capable of:
receiving, by the recipient email module, the email message;
identifying, by the recipient email module, the email message as a time-sensitive email message;
retrieving, by the recipient email module from the time server identified in the header, a current time;
determining, by the recipient email module, whether the current time conforms to the time to open the email message in the header; and
in response to determining that the current time conforms to the time to open the email message in the header, notifying, by the recipient email module, a user.

15. The computer program product of claim 13 further comprising computer program instructions capable of:
receiving, by the recipient email module, the email message;
identifying, by the recipient email module, the email message as a time-sensitive email message; and
placing, by the recipient email module, the email message in a designated folder.

16. The computer program product of claim 15 further comprising computer program instructions capable of:
periodically traversing, by the recipient email module, email messages in the designated folder including for each email message in the designated folder:
retrieving, by the recipient email module from the time server identified in the header of that email message, a current time;
determining, by recipient email module, whether the current time conforms to the time to open that email message identified in the header; and
in response to determining that the current time conforms to the time to open that email message in the header, notifying, by the recipient email module, a user.

17. The computer program product of claim 13 wherein inserting in the header of the email message an identification of the email message as a time-sensitive email message, an identification of a time-server, and a time to open the email message further comprises receiving from a sending user the identification of the time-server.

18. The computer program product of claim 13 wherein inserting in the header of the email message an identification of the email message as a time-sensitive email message, an identification of a time-server, and a time to open the email message further comprises retrieving a pre-configured identification of the time-server from data storage.

19. The computer program product of claim 13 wherein the signal bearing medium comprises a recordable medium.

20. The computer program product of claim 13 wherein the signal bearing medium comprises a transmission medium.
